(19) United States
(12) Patent Application Publication
(10) Pub. No.: US 2013/0140477 A1
(43) Pub. Date: Jun. 6, 2013

(54) ELECTRIC ACTUATOR AND CONTROL VALVE INCLUDING THE ELECTRIC ACTUATOR

(71) Applicant: DENSO CORPORATION, Kariya-city (JP)

(72) Inventor: Osamu SHIMANE, Kariya-city (JP)

(73) Assignee: DENSO CORPORATION, Kariya-city (JP)

(21) Appl. No.: 13/691,959

(22) Filed: Dec. 3, 2012

(30) Foreign Application Priority Data
Dec. 5, 2011 (JP) 2011-265381

(51) Int. Cl. H02K 7/116; F16K 31/02

(52) U.S. Cl. CPC H02K 7/116; F16K 31/02
USPC 251/129.01; 310/83

(57) ABSTRACT

An electric actuator includes a direct current (DC) motor, a deceleration mechanism having an input gear, an intermediate gear, an output gear, and an output shaft, and a return mechanism. The return mechanism includes a first resilient member and a second resilient member. The first resilient member is configured to apply resilient force, which urges a movable body in a direction to return the movable body from its displacement position to initial position, to the output shaft or the output gear. The second resilient member is configured to apply resilient force, which urges the movable body in the direction to return the movable body from its displacement position to initial position, to a motor shaft, the input gear, or the intermediate gear.

### CROSS REFERENCE TO RELATED APPLICATION

This application is based on Japanese Patent Application No. 2011-265381 filed on Dec. 5, 2011, the disclosure of which is incorporated herein by reference.

### TECHNICAL FIELD

The present disclosure relates to an electric actuator having a return mechanism for returning a movable body such as a valve from a displacement position to an initial position, and a control valve including the electric actuator.

### BACKGROUND

Conventional technologies will be described below. Conventionally, an intake throttle valve that opens or closes an intake passage in which intake air passing through an air cleaner flows, an exhaust throttle valve that opens or closes an exhaust passage in which exhaust gas discharged from the engine flows, an exhaust gas recirculation (EGR) control valve that opens or closes an exhaust gas recirculation passage in which EGR gas recirculating from the exhaust passage to the intake passage flows, and so forth are, where appropriate, disposed in a vehicle such as an automobile including an internal combustion engine (engine) (see, e.g., Japanese Patent No. 4793290, JP-A-2009-002325, and JP-A-2004-153914). As illustrated in FIG. 6, fluid control valves such as the intake throttle valve, the exhaust throttle valve, and the EGR control valve include a valve body 101 and a valve 102. In a fluid control valve such as the conventional EGR control valve, for the purpose of reduction of a leak flow rate of EGR gas in a valve fully-closed state, an annular recessed groove 103 is formed along the entire circumference of an outer peripheral end surface of the valve 102, and a C-shaped seal ring 104 is fitted in this recessed groove 103. Accordingly, when the valve 102 is fully closed, an outer peripheral surface of the seal ring 104 is in sliding contact with an inner peripheral surface of a cylindrical nozzle 105 that is fitted and fixed on the valve body 101. As a result, a leakage of EGR gas through a clearance between the outer peripheral surface of the seal ring 104 and the inner peripheral surface of the nozzle 105 can be prevented.

An electric actuator that rotates a rotatable shaft of the valve 102 by use of power (torque) of a direct current (DC) motor M is employed for a valve drive unit which drives the valve 102 of the fluid control valve, i.e., an actuator which opens or closes the valve 102. As illustrated in FIGS. 6 and 7, the electric actuator includes the DC motor M which generates power (torque) that drives the valve 102 in a valve-opening direction, a deceleration mechanism which reduces in two stages the rotation of this DC motor M, a return spring 106 which generates resilient force that urges the valve 102 in a direction to return the valve 102 from its valve opening position to valve fully-closed position, and a sensor cover 107 which defines a deceleration mechanism accommodating space between the valve body 101 and the cover 107. The DC motor M is accommodated and held in a motor case 108 having a cylindrical shape with a bottom that is formed integrally with the valve body 101. This DC motor M is a direct current (DC) motor with a brush including a stator in which permanent magnets (field magnet) 111,112 are arranged, a rotor (armature) that is rotatably disposed radially inward of this stator with a predetermined gap therebetween, and brushes 121, 122 that feed power to this armature.

The stator of the DC motor M includes a cylindrical yoke 110 having a cylindrical shape with a bottom which surrounds the armature in its circumferential direction, and the field magnets 111, 112 that are fixed on an inner peripheral surface of this cylindrical yoke 110. The armature of the DC motor M includes a motor shaft 113 extending in the direction of the rotation axis, a rotor core (armature core) 114 fixed to this motor shaft 113, a rotor coil (multiphase armature coil) wound around this rotor core 114, and a commutator 115 fixed to the motor shaft 113. Teeth projecting radially toward an inner peripheral surface of the stator are provided on an outer peripheral part of the rotor core 114.

The deceleration mechanism includes an intermediate gear shaft 131 arranged in parallel with the motor shaft 113 of the DC motor M, an output shaft 132 connected to the valve 102 in an integrally rotatable manner, a motor gear 133 fixed to the motor shaft 113 of the DC motor M, an intermediate gear 134 rotatable around the intermediate gear shaft 131, and an output gear 135 fixed to the output shaft 132. A return mechanism with the return spring 106 being a main component thereof is disposed on a rear (output) side of the last force-increasing step (last reduction gear step) of the valve 102 in the electric actuator that is constituted of the DC motor M including the field magnets 111, 112, the commutator 115, and the brushes 121, 122, and the deceleration mechanism. Specifically, one end of the return spring 106 is engaged with a spring seat part of the output gear 135, and the other end of the return spring 106 is engaged with a spring seat part of the valve body 101. The return spring 106 is disposed to spirally surround the output shaft 132 of the deceleration mechanism, an intermediate cylindrical part 141 of the output gear 135, and an intermediate cylindrical part 142 of the valve body 101.

In the conventional fluid control valve, particularly, the exhaust throttle valve and the EGR control valve, the valve 102 is accommodated in a passage through which exhaust gas containing exhaust particles (particulate matter: PM) such as combustion residuum and carbon flows. Accordingly, when foreign substances such as the exhaust particles are attached on a surface of the valve 102 of the fluid control valve, the surface of the seal ring 104, or the inner peripheral surface of the nozzle 105 thereby to form deposits, the deposits are bitten in a minute clearance between the outer peripheral surface of the seal ring 104 and the inner peripheral surface of the nozzle 105, so that the valve 102 is firmly fixed (stuck). Thus, to cope with the adhesion due to the deposits, it is necessary to generate great torque in the output shaft 132 of the deceleration mechanism that is connected to the valve 102 in an integrally rotatable manner. To this end, a reduction ratio of the output shaft 132 of the deceleration mechanism of the electric actuator and the valve 102 fixed to this output shaft 132 needs to be made large.

The DC motor with the brush having the stator in which the field magnets 111, 112 are fixed on an inner peripheral surface of the cylindrical yoke 110 having a cylindrical shape with a bottom, the armature which is supported rotatably relative to this stator, and the brushes 121, 122 that feed power to the armature coil of this armature is employed for the DC motor M which generates the power for driving the valve 102 which is a valving element of the fluid control valve. The commutator 115 which is electrically connected to the armature coil is in pressing contact with the brushes 121, 122 for the power feeding, and a direct current is supplied to the armature coil via these brushes 121, 122. Upon supply of the direct current to the armature coil, a magnetic field is formed, and the armature rotates due to magnetic attraction and repulsion produced between this magnetic field and the field magnets 111, 112.

In the DC motor M, the magnetic attraction force is generated between the field magnets 111, 112 and the armature, and this magnetic attraction force becomes a magnetic resistance fluctuation against the rotation of the armature, to generate cogging torque in the motor shaft 113. Because this cogging torque causes vibration and noise, the cogging torque may be made small. However, in the case where the electric actuator which drives the valve 102 is constituted of the DC motor M and the deceleration mechanism, the motor shaft 113 is rotated with rotation unevenness by a fluctuation (torque fluctuation) of output torque of the DC motor M because of the cogging torque between the field magnets 111, 112 and the armature.

When the reduction ratio of the output shaft 132 of the deceleration mechanism and the valve 102 fixed to this output shaft 132 is made large in order to generate the large torque in the output shaft 132 of the deceleration mechanism for the above reason, the torque fluctuation (rotation unevenness and vibration) due to the cogging torque of the DC motor M is increased (amplified) in the output shaft 132 of the deceleration mechanism by the amount of the reduction ratio. When the rotation unevenness of the motor shaft 113 is transmitted to the output shaft 132 of the deceleration mechanism, engaging portions between the intermediate gear 134 and the output gear 135 slide on each other, and gear wear is thereby increased (advanced). In addition, by a reduction of efficiency in power transmission between the intermediate gear 134 and the output gear 135 due to the gear wear between the intermediate gear 134 and the output gear 135, through the long-term durable use of the deceleration mechanism, the torque fluctuation because of the cogging torque in the output shaft 132 of the deceleration mechanism tends to be increased (amplified).

When the valve 102 is located at a predetermined valve-opening position in the fluid control valve, reaction force (spring torque) of the return spring 106 needs to be made large to improve reliability in the return of the valve 102 from the valve-opening position to a fully-closed position which is an initial position. However, when the spring torque of the return spring 106 is made larger than the present state, the torque generated by the output shaft 132 of the deceleration mechanism is reduced. Accordingly, the gear wear increases in accordance with a load increase, and the efficiency in power transmission between the intermediate gear 134 and the output gear 135 is thereby lowered. Therefore, for the purpose of limitation of the reduction of efficiency in power transmission between the intermediate gear 134 and the output gear 135, a high-cost material which is excellent in wear resistance needs to be used for a material of the output gear 135 to limit the progression of the gear wear between the intermediate gear 134 and the output gear 135. Nevertheless, if an expensive material which is excellent in wear resistance is used for the material of the reduction gear, an issue of increase in product costs of the deceleration mechanism, and further, the electric actuator arises.

### SUMMARY

The present disclosure addresses at least one of the above issues.

According to the present disclosure, there is provided an electric actuator for driving a movable body. The electric actuator includes a direct current (DC) motor, a deceleration mechanism, and a return mechanism. The DC motor is configured to generate power which drives the movable body in its movement direction. The deceleration mechanism includes an input gear, an intermediate gear, an output gear, and an output shaft. The input gear is fixed to a motor shaft of the DC motor. The intermediate gear is rotated in engagement with the input gear. The output gear is rotated in engagement with the intermediate gear. The output shaft is coupled with the output gear to be rotatable integrally with the output gear. The deceleration mechanism is configured to decelerate rotation of the motor shaft and to transmit the decelerated rotation to the output shaft. The return mechanism includes a first resilient member and a second resilient member. The first resilient member is configured to apply resilient force, which urges the movable body in a direction to return the movable body from its displacement position to initial position, to the output shaft or the output gear. The second resilient member is configured to apply resilient force, which urges the movable body in the direction to return the movable body from its displacement position to initial position, to the motor shaft, the input gear, or the intermediate gear.

According to the present disclosure, there is also provided a control valve including the electric actuator, a housing, and the movable body. The housing defines a flow passage through which fluid flows. The movable body is a valve configured to open or close the flow passage. The DC motor is configured to generate power which drives the valve in its opening direction.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a sectional view illustrating an EGR control valve in accordance with a first embodiment;

FIG. 2 is a sectional view illustrating the EGR control valve of the first embodiment;

FIG. 3 is a front view illustrating a spiral spring according to the first embodiment;

FIG. 4 is a sectional view illustrating an EGR control valve in accordance with a second embodiment;

FIG. 5 is a front view illustrating a spiral spring according to the second embodiment;

FIG. 6 is a sectional view illustrating a previously proposed EGR control valve; and

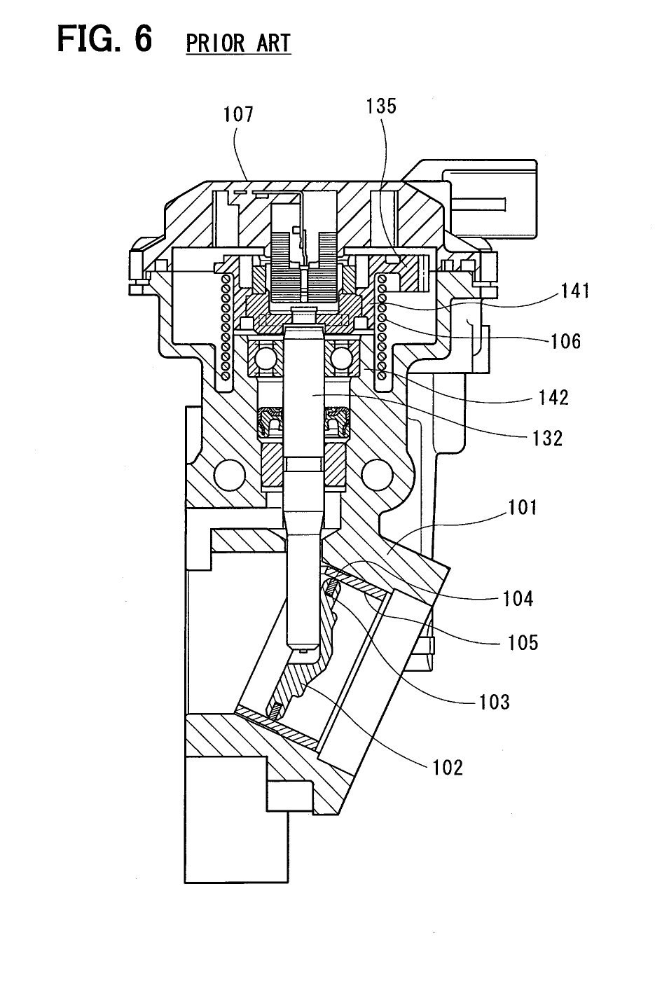

FIG. 7 is a sectional view illustrating a previously proposed electric actuator.

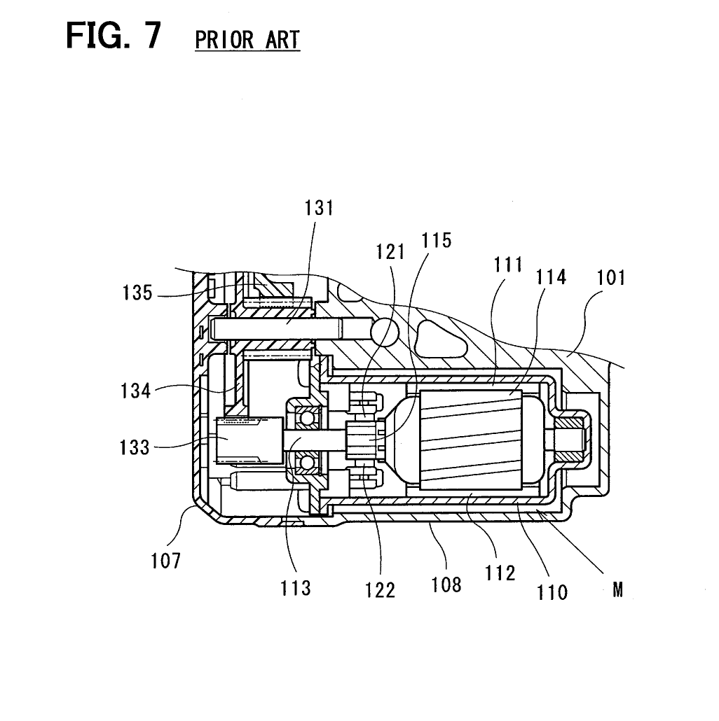

### DETAILED DESCRIPTION

Embodiments will be described in detail below with reference to the accompanying drawings. In the present disclosure, a return mechanism that returns a movable body such as a valve from a displacement position to an initial position is configured by a first resilient member that gives resilient force to an output shaft or an output gear of a deceleration mechanism, and a second resilient member that gives resilient force to a motor shaft, an input gear, or an intermediate gear. Accordingly, a transmission of torque fluctuation (rotation unevenness and vibration) due to cogging torque generated in the motor shaft of a direct current motor to the output shaft of the deceleration mechanism is limited without use of an expensive material which is excellent in wear resistance. In addition, a progression of gear wear of the intermediate gear and the output gear of the deceleration mechanism is limited without use of an expensive material which is excellent in wear resistance.

### First Embodiment

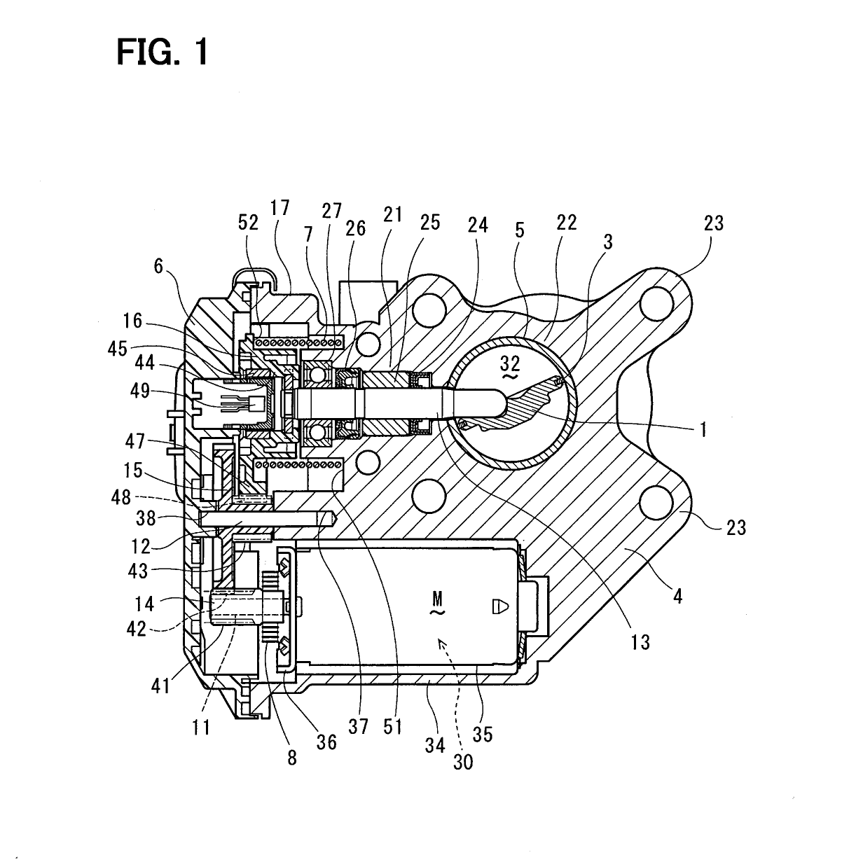

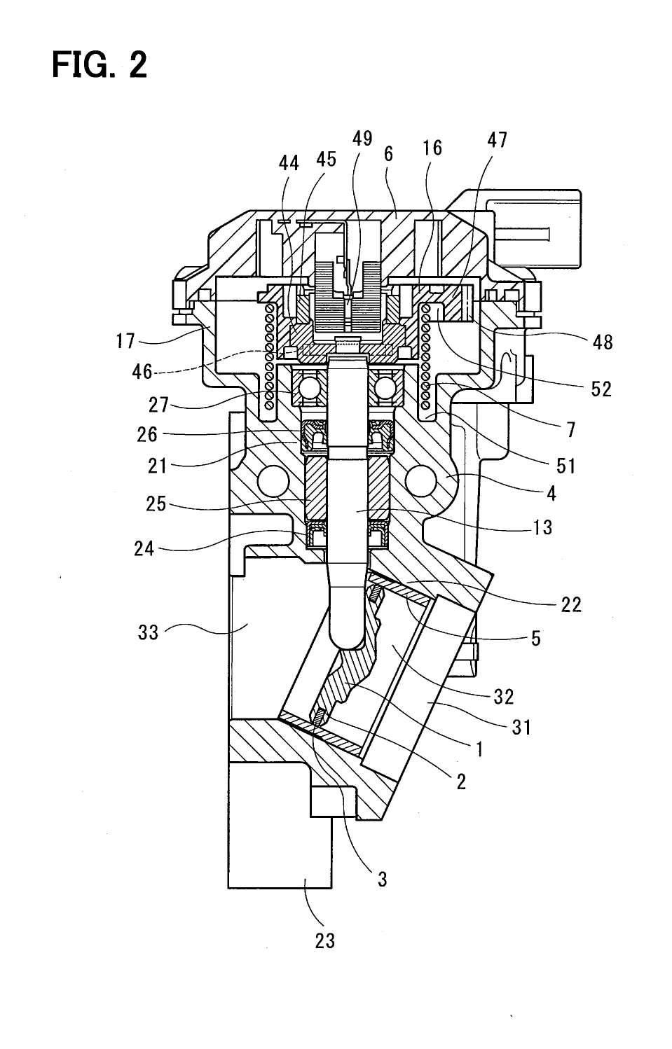

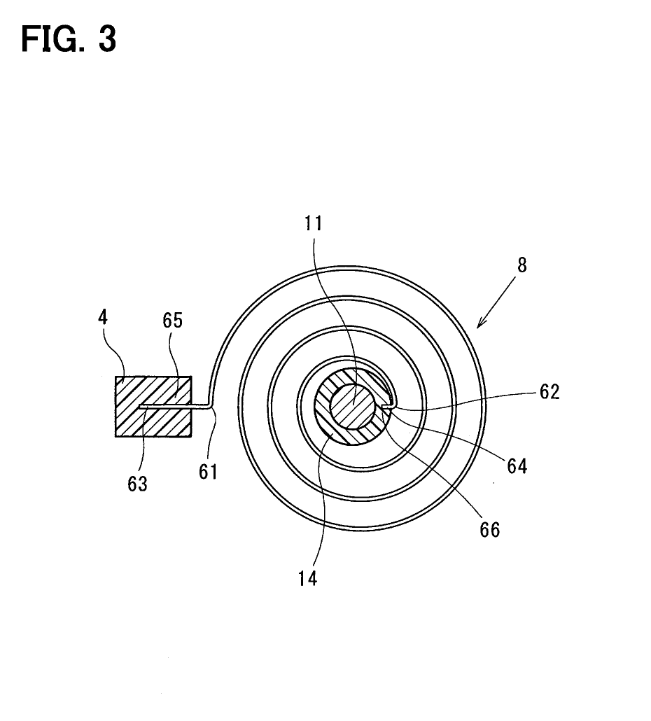

Configuration of a first embodiment will be described below. FIGS. 1 to 3 illustrate the first embodiment. FIGS. 1 and 2 illustrate an EGR control valve, and FIG. 3 illustrates a main part (spiral spring) of a return mechanism of an electric actuator.

A control device (engine control system) of an internal combustion engine of the present embodiment includes an exhaust gas recirculation system (EGR system) that recirculates (returns) EGR gas, which is a part of exhaust gas discharged from a combustion chamber for each cylinder of an internal combustion engine (engine) such as a diesel engine, from an exhaust pipe into an intake pipe. The engine control system is used as an exhaust gas purification system that purifies exhaust gas discharged from the engine. This EGR system includes an exhaust gas control valve (hereinafter referred to as an EGR control valve) that opens or closes an exhaust gas recirculation passage (EGR gas passage) through which EGR gas is recirculated (returned) from an exhaust passage into an intake passage, and an engine control unit (electrical control unit: ECU) that variably controls an opening degree of the EGR control valve corresponding to an operation condition of the engine. The ECU is configured to perform the control of the EGR control valve in association with systems such as an intake air throttle device (intake throttle valve that opens or closes the intake passage of the engine) and an exhaust gas throttle device (exhaust throttle valve that opens or closes the exhaust passage of the engine).

A multicylinder diesel engine having more than one cylinder is employed for the engine of the present embodiment. Alternatively, the engine of the present embodiment is not limited to the multicylinder diesel engine, and a multicylinder gasoline engine may be applied. The engine is disposed in an engine compartment of a vehicle such as an automobile along with the EGR system and a fuel supply system. The engine includes the intake pipe (air intake duct) that defines the intake passage, through which the intake air passing through an air cleaner and a throttle body to be drawn into the combustion chamber for each cylinder flows; and the exhaust pipe (exhaust duct) that defines the exhaust passage, through which the exhaust gas discharged from the combustion chamber for each cylinder is discharged into the outside.

The exhaust pipe and the intake pipe are connected together through an exhaust gas recirculation pipe (EGR gas pipe) that defines the EGR gas passage. An upstream end portion of the EGR gas pipe is connected to an EGR gas branched part of the exhaust pipe, and a downstream end portion of the EGR gas pipe is connected to an EGR gas merging part of the intake pipe. The EGR control valve that controls a flow rate of EGR gas flowing through the EGR gas passage by its opening and closing operation, and an EGR cooler that exchanges heat of EGR gas with coolant to cool the EGR gas are provided for the EGR gas pipe. As described above, the EGR system is constituted of the EGR gas pipe, the EGR control valve, the EGR cooler, and the ECU. In this EGR system, when the EGR control valve is open, a part of exhaust gas discharged from the engine is returned into the intake passage as the EGR gas via the EGR gas pipe. In addition, the EGR cooler does not need to be provided.

Details of the EGR control valve of the present embodiment will be briefly explained with reference to FIGS. 1 to 3. The EGR control valve is an EGR gas recirculated amount control valve (exhaust control valve) that controls an EGR rate which is a ratio of the EGR gas amount to the total flow rate of intake air (newly drawn air) supplied to the combustion chamber for each cylinder of the engine. The EGR control valve includes a housing that is joined to a halfway portion of the EGR gas pipe, an EGR valve 1 made of metal that is accommodated rotatably in this housing, a seal ring 3 made of metal that is fitted in a seal ring groove (annular groove) 2 formed on an outer peripheral end surface of this EGR valve 1, and an actuator that changes an opening degree of the EGR valve 1.

The housing includes a valve body 4 made of metal, a nozzle 5 made of metal, and a sensor cover 6 made of synthetic resin. The EGR valve 1 and the seal ring 3 are accommodated in the valve body 4 and the nozzle 5. The valve body 4 includes an accommodating space that accommodates the actuator formed between the valve body 4 and the sensor cover 6. In the EGR control valve, an electric actuator including a direct current (DC) motor M and a reduction gear mechanism (hereinafter referred to as the deceleration mechanism) is employed for a valve drive unit which drives the EGR valve 1, i.e., an actuator that opens or closes the EGR valve 1. The DC motor M, which is a power source of this electric actuator is electrically connected to a battery disposed in a vehicle such as an automobile via a motor drive circuit electronically controlled by the ECU.

The electric actuator includes the DC motor M, the deceleration mechanism, and a return mechanism. This return mechanism includes a return spring 7 and a spiral spring 8. The DC motor M includes an inner rotor (armature) 30 that has a motor shaft 11 extending in an axial direction (hereinafter referred to as a rotation axis direction), a cylindrical stator that surrounds this armature in its circumferential direction (motor circumferential direction), and a pair of feed brushes (first and second brushes) that are accommodated and held by a brush holder fixed to this stator.

The deceleration mechanism includes an intermediate gear shaft (intermediate shaft) 12 that is arranged in parallel with the motor shaft 11 of the DC motor M, an output shaft (an output gear shaft, a valve stem) 13 that is connected to the EGR valve 1 in an integrally rotatable manner, and three first to third reduction gears that rotate in synchronization with the motor shaft 11. The three the first to third reduction gears include a pinion gear (an input gear, a motor gear) 14 made of metal, an intermediate gear 15 made of metal, and a last gear (an output gear, a valve gear) 16 made of metal. The three first to third reduction gears are accommodated rotatably in a reduction gear accommodating space formed between a gear case 17 and the sensor cover 6 formed integrally with the valve body 4. In addition, details of the electric actuator will be discussed later.

Details of the EGR valve 1 of the present embodiment will be briefly described in reference to FIGS. 1 and 2. The EGR valve 1 is formed in a disc shape from iron system metal such as stainless steel. This EGR valve 1 is welded and fixed to one end part (first projecting part) of the output shaft 13 of the deceleration mechanism in its rotation axis direction. The annular seal ring groove 2 is formed continuously on the outer peripheral end surface of the EGR valve 1 in a circumferential direction of the valve 1. The C-shaped seal ring 3 is fitted in this seal ring groove 2.

The seal ring 3 is formed in a circular ring shape from iron system metal such as stainless steel. This seal ring 3 includes a predetermined notch clearance (closed gap) between its both end faces in the circumferential direction in view of its attachment to the seal ring groove 2 of the EGR valve 1, or in preparation for expansion and contraction of the seal ring 3 because of a thermal expansion difference between the nozzle 5 and the seal ring 3. An outer peripheral surface (sliding part) that can be closely-attached on an inner diameter surface of the nozzle 5 (valve seat surface) is provided on a radially outward end face of the seal ring 3. Edges of the sliding part of this seal ring 3 on its both sides in the axial direction may be chamfered in a tapered shape or a round shape to facilitate the opening and closing operations of the EGR valve 1.

An outer peripheral lateral part of the seal ring 3 projects radially outward of the outer peripheral end surface of the EGR valve 1, and an inner peripheral lateral part of the seal ring 3 is fitted and held in the seal ring groove 2 to be movable in the seal ring groove 2 in the radial direction, axial direction, and circumferential direction. Accordingly, the EGR control valve of the present embodiment is configured to tightly cover (air-tightly seal) an annular clearance formed between the valve seat surface of the nozzle 5 and the outer peripheral end surface of the EGR valve 1 by means of tension of the seal ring 3 in the radial direction (diameter increasing direction) that is perpendicular to the axial direction of the seal ring 3 which is fitted in the seal ring groove 2 of the EGR valve 1, when the engine is stopped or when EGR gas is not introduced (at EGR cut time).

The valve body 4 is formed integrally from aluminum system metal such as aluminum alloy. A cylindrical bearing sleeve 21 that surrounds an intermediate part of the output shaft 13 of the deceleration mechanism in its circumferential direction, a cylindrical nozzle holder 22 that surrounds the nozzle 5 in its circumferential direction, and a stay 23 that is fastened to a coupling flange of the intake pipe, the exhaust pipe, or the EGR gas pipe via a screw are integrally provided for this valve body 4. A bearing hole through which the intermediate part of the output shaft 13 passes in its rotation axis direction is formed inside the bearing sleeve 21. Bearing members (a dust seal 24, a bushing 25, an oil seal 26 and a ball bearing 27) are held in this bearing hole. The nozzle 5 for protecting the valve body 4 from the heat of EGR gas is fitted and held in the nozzle holder 22.

The nozzle 5 is formed in a cylindrical shape from iron system metal such as stainless steel. The valve seat surface, with which the outer peripheral surface (sliding part) of the seal ring 3 which is fitted in the seal ring groove 2 of the EGR valve 1 is in sliding contact, is provided on an inner peripheral surface of this nozzle 5. Passage holes 31 to 33 communicating with the combustion chamber for each cylinder of the engine are respectively formed inside the valve body 4 and the nozzle 5. These passage holes 31 to 33 are the EGR gas passages, through which EGR gas flows back from the EGR gas branched part of the exhaust pipe to the EGR gas merging part of the intake pipe.

Details of the electric actuator of the present embodiment will be described with reference to FIGS. 1 to 3. The electric actuator includes the DC motor M that generates power which drives the EGR valve 1 upon supply of electric power, the deceleration mechanism (power transmission mechanism) that decelerates in two steps the rotation of this DC motor M and transmits the rotation to the output shaft 13, the return mechanism that returns the EGR valve 1 from a predetermined valve opening position to a fully-closed position, and a rotation angle (EGR opening degree) detecting device that detects a rotation angle (opening degree) of the EGR valve 1.

The DC motor M is accommodated and held in a motor case 34 having a cylindrical shape with a bottom that is formed integrally with the valve body 4. This DC motor M is supported and fixed in the motor case 34 by fastening by a screw or the like a front bracket 36 which is connected on a front side of a cylindrical yoke 35 to an opening peripheral edge part of a motor insertion opening of the motor case 34. The DC motor M is a DC motor with a brush in which an inner rotor 30 is arranged on an inner peripheral side of an outer stator to be rotatable relatively thereto. The DC motor M includes the armature having the motor shaft 11 extending straightly in the rotation axis direction, the cylindrical stator that surrounds this armature in its circumferential direction (motor circumferential direction), and the pair of (first and second) brushes that are in pressing contact with the commutator fixed to the motor shaft 11.

The stator includes the yoke 35 having a cylindrical shape with a bottom, and permanent magnets (field magnets) fixed on an inner peripheral surface of this cylindrical yoke 35. The pair of (first and second) brushes are arranged at intervals of 180 degrees in the motor circumferential direction and such that they are opposed to each other. The first brush is connected to a positive electrode side (VCC side) of an external power (battery) via an electric power supply line. The second brush is connected to a negative electrode side (ground side, GND side) of the external power (battery) via an electric power supply line.

The armature is disposed radially inward of the stator with a predetermined gap therebetween. This armature includes the motor shaft 11 that is rotatably supported by respective bearing supporting portions (bearing holders) of the cylindrical yoke 35 and the front bracket 36 through shaft bearings (bearings), an armature core that is formed by stacking magnetic steel plates in the rotation axis direction of this motor shaft 11, an armature winding (armature coil) that is wound on this armature core, and the commutator with which the pair of (first and second) brushes are in pressing contact.

The armature core is formed using a laminated iron core, and includes a fitted part that is press-fitted to the outer periphery of the motor shaft 11 and has a cylindrical shape (or angulated cylindrical shape), and teeth that project from an outer peripheral surface of this fitted part. The teeth are arranged at regular intervals on the outer peripheral surface of the fitted part in its circumferential direction. The teeth include a teeth winding part that projects radially outward of the armature from the outer peripheral surface of the fitted part of the armature core, and a teeth magnetic pole part that extends on both sides in the motor circumferential direction from an outer peripheral end of this teeth winding part. An outer peripheral surface of this teeth magnetic pole part is opposed to the inner peripheral surface of the stator.

A through hole that passes through the fitted part in its rotation axis direction is formed at a central part of the fitted part of the armature core. The motor shaft 11 is fixed to this through hole. Slots that accommodate each phase coil of the armature winding are formed between the respective teeth which are adjacent in the circumferential direction of the armature core. The armature winding is wound by a concentrated winding method around the teeth winding parts of the teeth, and is constituted of multiphase each phase coil accommodated in the slots. Each phase coil is wound outside the teeth winding parts via an insulator.

The deceleration mechanism includes the intermediate gear shaft 12 that is arranged in parallel with the motor shaft 11 of the DC motor M, the output shaft 13 that is arranged in parallel with the motor shaft 11 and the intermediate gear shaft 12, the pinion gear 14 that is press-fitted and fixed to the outer periphery of the motor shaft 11, the intermediate gear 15 that rotates in engagement with this pinion gear 14, and the last gear 16 that rotates in engagement with this intermediate gear 15. The intermediate gear shaft 12 is integrally formed in a cylindrical shape (round bar form) from iron system metal such as stainless steel (or non-iron system metal). One end of this intermediate gear shaft 12 in its axial direction is press-fitted (fixed) in a fitting recess 37 of the valve body 4. The other end of the intermediate gear shaft 12 in the axial direction is fitted in a fitting recess 38 of the sensor cover 6.

The output shaft 13 is integrally formed in a cylindrical shape (round bar shape) from iron system metal (or non-iron system metal) such as stainless steel. This output shaft 13 is accommodated rotatably in the bearing sleeve 21 of the valve body 4. The first projecting part that projects from an open end surface of the bearing hole of the bearing sleeve 21 into the passage holes 32, 33 is provided at one end part of the output shaft 13 in its rotation axis direction. The EGR valve 1 is welded and fixed to the first projecting part. A second projecting part that projects from an open end surface of the bearing sleeve 21 of the valve body 4 into the reduction gear accommodating space is provided at the other end part of the output shaft 13 in the rotation axis direction. A last gear plate (described in greater detail hereinafter) for connection with the last gear 16 of the deceleration mechanism is fixed to the second projecting part.

The pinion gear 14 is integrally formed from a metal material or synthetic resin. This pinion gear 14 is disposed coaxially with (e.g., on the same axis as) the motor shaft 11 of the DC motor M. The pinion gear 14 includes a diameter that is smaller than a gear diameter of a maximum outer diameter part (major diameter gear) of the intermediate gear 15. This pinion gear 14 is fixed to an outer periphery of the end of the motor shaft 11 of the DC motor M by press-fitting or the like, and includes a cylindrical part that rotates integrally with the motor shaft 11 of the DC motor M. Projecting gear teeth (pinion gear teeth 41) are formed on an outer periphery of the cylindrical part of the pinion gear 14 in its entire circumferential direction.

The intermediate gear 15 is integrally formed from synthetic resin. This intermediate gear 15 is fitted around an outer periphery of the intermediate gear shaft 12, which is arranged in parallel with the motor shaft 11 of the DC motor M and the output shaft 13 of the deceleration mechanism, to be rotatable relatively thereto. The intermediate gear 15 includes a cylindrical part that is fitted rotatably around the outer periphery of the intermediate gear shaft 12 and is rotated around the axis line of the intermediate gear shaft 12.

A major diameter gear that is in engagement with the pinion gear teeth 41 of the pinion gear 14 is formed at one end part of the cylindrical part of the intermediate gear 15 in its axial direction. The major diameter gear is larger than an outer diameter of the cylindrical part. This major diameter gear includes a larger diameter part in the shape of a circular ring plate that is provided at one end part of the cylindrical part in its axial direction, and projecting gear teeth (intermediate gear teeth 42) formed on an outer periphery of this larger diameter part in its entire circumferential direction. The major diameter gear includes a diameter that is larger than a gear diameter of a maximum outer diameter part (gear part) of the last gear 16. A minor diameter gear that is in engagement with the last gear 16 is formed at the other end part of the cylindrical part of the intermediate gear 15 in the axial direction. This minor diameter gear includes the cylindrical part of the intermediate gear 15, and projecting gear teeth (intermediate gear teeth 43) formed on an outer periphery of this cylindrical part in its entire circumferential direction. The intermediate gear teeth 43 have a gear diameter that is smaller than a gear diameter of the intermediate gear teeth 42.

The last gear 16 is integrally formed from synthetic resin. A cylindrical magnet rotor 44 is integrally formed in an inner peripheral part of this last gear 16. A sensor magnet 45, which is a permanent magnet, is fixed to an inner periphery of this magnet rotor 44. A last gear plate 46 made of metal including therein a through hole which has a width across flat (configuration for preventing the output shaft 13 from spinning free: anti-rotation configuration) is insert-molded in the magnet rotor 44. Accordingly, the last gear 16 is fixed to the other end part of the output shaft 13 in the rotation axis direction (second projecting part) via the last gear plate 46 in an anti-rotation state.

The last gear 16 includes a maximum outer diameter part 47 having a partially cylindrical shape radially outward of the magnet rotor 44. Projecting gear teeth (output gear teeth 48) which are in engagement with the intermediate gear teeth 43 of the intermediate gear 15 are provided in fan-like fashion by a predetermined angle for this maximum outer diameter part 47. The output gear teeth 48 include a larger gear diameter than a gear diameter of the intermediate gear teeth 43. The last gear 16 serves as the last reduction gear (last-step reduction gear in the deceleration mechanism) that is connected to the output shaft 13 of the deceleration mechanism in an integrally rotatable manner. This last gear 16 is fixed to the other end part of the output shaft 13 in the rotation axis direction (second projecting part) in an anti-rotation state.

The last gear 16 includes an intermediate cylindrical part between the magnet rotor 44 and the maximum outer diameter parts 47. An outer peripheral surface of this intermediate cylindrical part serves as a spring inner peripheral guide that holds a coil inside diameter side of the return spring 7 together with an outer peripheral surface of the bearing sleeve 21 of the valve body 4. The return spring 7 that urges the EGR valve 1 in the valve-closing direction is spirally wound around an outer periphery of the bearing sleeve 21 of the valve body 4 and an outer periphery of the intermediate cylindrical part of the last gear 16.

A microcomputer with a well-known configuration configured to include functions such as a central processing unit (CPU) which performs control processing and arithmetic processing, a storage device (memory such as a read only memory (ROM) or a random access memory (RAM)) that stores a control program, a control logic, or various kinds of control data (e.g., map), an input circuit (input part), an output circuit (output part), a power supply circuit, and a timer circuit are provided for the ECU. The ECU is configured to control energization of the electric actuator (DC motor M) of the EGR control valve based on the control program or the control logic stored in the memory of the microcomputer when an ignition switch is turned on (IG-ON).

The ECU is configured such that sensor output signals from various kinds of sensors such as an EGR (valve) opening sensor 49, an airflow meter, a crank angle sensor, an accelerator opening sensor, a throttle opening sensor, a coolant temperature sensor, and an exhaust gas sensors (air fuel ratio sensor and oxygen concentration sensor) are A/D converted by an A/D conversion circuit, and then are inputted into the microcomputer. The EGR opening sensor 49, the airflow meter, the crank angle sensor, the accelerator opening sensor, the throttle opening sensor, the coolant temperature sensor, and the exhaust gas sensor serve as an operational state detection means for detecting an operational state (operation condition) of the engine.

The rotation angle detecting device includes the cylindrical magnet rotor 44 that is connected to the EGR valve 1 in an integrally rotatable manner, and the EGR opening sensor 49 that measures a rotation angle of this magnet rotor 44 to detect an EGR valve opening degree corresponding to a rotation angle of the output shaft 13 of the deceleration mechanism. The sensor magnets 45 which are permanent magnets, and the rotor core which is a magnetic material are attached on an inner peripheral surface of the magnet rotor 44.

The EGR opening sensor 49 is held between opposed parts of a pair of stator cores disposed at a sensor mounting portion of the sensor cover 6. This EGR opening sensor 49 is disposed to project from the sensor mounting portion toward the valve body. The EGR opening sensor 49 is configured with a Hall IC which outputs a voltage signal (analog signal) corresponding to a density of magnetic flux interlinking with a magnetic sensitive surface of a semiconductor Hall element, to the ECU, as a main component thereof. In addition, instead of the Hall IC, a non-contact type magnetism detecting element such as a Hall element alone or a magnetic resistance element may be used.

The return mechanism of the electric actuator includes the return spring (coil spring) 7 that is disposed to spirally surround the output shaft 13 of the deceleration mechanism, and the spiral spring 8 that is disposed to vorticosely surround the motor shaft 11 of the DC motor M. The return mechanism is configured to return the EGR valve 1 from a predetermined valve-opening position to a fully-closed position by use of the resilient force (reaction force) of the return spring 7, and the resilient force (reaction force) of the spiral spring 8.

The return spring 7 is a coiled return spring (first resilient member) that applies urging force (spring load, spring force) for urging the EGR valve 1 in the valve-closing direction to the output shaft 13 and the last gear 16 of the deceleration mechanism. This return spring 7 is a first resilient force applying means (first spring) for applying the resilient force that urges the EGR valve 1 in a direction (valve-closing direction) to return the EGR valve 1 from the valve-opening position which is a displacement position to the fully closed position which is an initial position, to the output shaft 13 and the last gear 16 of the deceleration mechanism.

The return spring 7 includes a coil part that is wound to spirally surround the output shaft 13 of the deceleration mechanism and the intermediate cylindrical part of the last gear 16 between a spring seat part 51 of the valve body 4 and a spring seat part 52 of the last gear 16. An annular first coil end part that is in contact with the spring seat part 51 of the valve body 4 is provided on one end side (valve body side) of the return spring 7 in its axial direction. An annular second coil end part that is in contact with the spring seat part 52 of the last gear 16 is provided on the other end side (last gear side) of the return spring 7 in the axial direction.

The return spring 7 includes a first hook portion that projects in its tangential direction from a terminal section of the first coil end part, and a second hook portion that extends radially outward from a terminal section of the second coil end part. The first hook portion is held by an annular recess (not shown) provided for the valve body 4. The second hook portion is held by an annular recess (not shown) provided for the last gear 16.

The spiral spring 8 is a spiral return spring (second resilient member) that applies the urging force (spring load, spring force) that urges the EGR valve 1 in the valve-closing direction to the motor shaft 11 of the DC motor M and the pinion gear 14 of the deceleration mechanism. This spiral spring 8 is a second resilient force applying means (second spring) for applying the resilient force that urges the EGR valve 1 in the direction (valve-closing direction) to return the EGR valve 1 from the valve-opening position which is a displacement position, to the fully closed position which is an initial position, to the motor shaft 11 of the DC motor M and the pinion gear 14.

The spiral spring 8 includes a spiral portion that is wound to vorticosely surround the motor shaft 11 of the DC motor M and the cylindrical part of the pinion gear 14 of the deceleration mechanism. A first end part (maximum outer diameter part) 61 of the spiral portion is provided on one end side (valve body side) of the spiral spring 8 in its spiral direction. A second end part (minimum inner diameter part) 62 of the spiral portion is provided on the other end side (pinion gear side) of the spiral spring 8 in the spiral direction. The spiral spring 8 includes a first hook portion 63 that projects (extends) outwardly in a radial direction of the spiral portion from a terminal part of the first end part 61 of the spiral portion, and a second hook portion 64 that projects (extends) inwardly in the radial direction from a terminal part of the second end part 62 of the spiral portion.

The first hook portion 63 is embedded and fixed (held or engaged) in a spring holding part 65 that is provided at the gear case 17-side of the valve body 4, or the stator (attachment member such as the front bracket 36) of the DC motor M. The second hook portion 64 is embedded and fixed (held or engaged) in a spring holding part 66 that is provided at the motor shaft 11 of the DC motor M or the cylindrical part of the pinion gear 14 of the deceleration mechanism. In addition, the spring holding part 65 may be a block (fixation member fixed to the housing) made of synthetic resin that is press-fitted (fixed) in an outer wall surface of the valve body 4, i.e., a fitting recess provided on a bottom face of the gear case 17.

The operation of the EGR control valve of the present first embodiment will be briefly described with reference to FIGS. 1 to 3.

Energization of the DC motor M that rotates the EGR valve 1 of the EGR control valve of the present embodiment is controlled by the ECU. First, when electric power is not supplied to the DC motor M, the EGR valve 1 is set at the fully-closed position (initial position) by the resilient force (reaction force) of the return spring 7 and the spiral spring 8.

Meanwhile, the sliding part of the seal ring 3 which is fitted in the seal ring groove 2 of the EGR valve 1 is stuck on the valve seat surface of the nozzle 5 fitted and held in the nozzle holder 22 of the valve body 4 due to the tension (resilient deformation force) of the seal ring itself in the diameter increasing direction. Accordingly, the sliding part of the seal ring 3 is closely-attached on the valve seat surface of the nozzle 5. Therefore, a clearance between the outer peripheral end surface of the EGR valve 1 and the inner peripheral surface of the nozzle 5 is fully sealed. Thus, the passage holes 31 to 33 are closed. As a result, EGR gas is not mixed (EGR cut) into clean intake air (fresh air) which has passed through the air cleaner.

Next, when the engine is put in the operation condition (engine operation condition) in which the EGR control valve is opened, the EGR valve 1 is made to open such that it opens at a predetermined target opening degree (displacement position, valve-opening position) corresponding to the operation condition. Then, the electric power is supplied to the DC motor M to rotate the motor shaft 11 of the DC motor M in the valve-opening direction. Accordingly, the power (torque) of the DC motor M is transmitted to the pinion gear 14, the intermediate gear 15, and the last gear 16. The output shaft 13, to which the torque is transmitted from the last gear 16, rotates in the valve-opening direction by a predetermined rotation angle (valve opening degree) in accordance with the rotation of the last gear 16.

As described above, through the variable control of the electric power supplied to the DC motor M (drive current value or applied voltage value) corresponding to the engine operation condition, the valve opening degree of the EGR control valve is changed. Accordingly, the amount of EGR gas introduced (mixing amount) into the clean intake air which has passed through the air cleaner is adjusted. Thus, the EGR valve 1 is controlled to open at the valve opening degree (valve-opening position) corresponding to the control target value (predetermined displacement position). As a result, the passage holes 31 to 33 are opened.

Therefore, the EGR gas, which is a part of exhaust gas flowing out of the combustion chamber for each cylinder of the engine, is recirculated to the intake passage (EGR gas merging part) defined in the intake pipe from the exhaust passage (EGR gas branched part) defined in the exhaust pipe through the inside of the exhaust pipe-side EGR gas pipe (EGR gas passage), the internal passage of the valve body 4 of the EGR control valve (EGR gas introduction port, passage holes 31 to 33, and EGR gas discharge port in this order), and the inside of the intake pipe-side EGR gas pipe (EGR gas passage) in this order. Accordingly, the EGR gas is mixed into intake air supplied to an intake port and the combustion chamber for each cylinder of the engine. As a result, harmful substances (e.g., NOx) contained in the exhaust gas are reduced.

Effects of the first embodiment will be described below. As described above, in the EGR control valve of the present embodiment, the return mechanism of the electric actuator that drives the EGR valve 1 in the direction (valve-opening direction) to open the EGR valve 1 from the fully-closed position to the valve-opening position which is the target opening degree, is configured by means of the return spring 7 which applies the resilient force that urges the EGR valve 1 in the direction (valve-closing direction) to return the EGR valve 1 from the valve-opening position to the fully-closed position, to the output shaft 13 or the last gear 16 of the deceleration mechanism; and the spiral spring 8 which applies the resilient force that urges the EGR valve 1 in the direction (valve-closing direction) to return the EGR valve 1 from the valve-opening position to the fully-closed position, to the motor shaft 11 of the DC motor M and the pinion gear 14. Accordingly, the cogging torque between the field magnet of the DC motor M and the teeth of the armature (inner rotor) 30 can be cancelled out.

As described above, by providing the spiral spring 8 that applies resilient force to the motor shaft 11 of the DC motor M and the pinion gear 14, despite the reduction of efficiency in power transmission of the deceleration mechanism provided between the motor shaft 11 and the output shaft 13 through the long-term durable use of the EGR control valve, a torque fluctuation (rotation unevenness and vibration) due to the cogging torque generated in the motor shaft 11 of the DC motor M is not easily transmitted to the output shaft 13 of the deceleration mechanism.

Accordingly, the torque of the return spring 7 which gives resilient force to the output shaft 13 and the last gear 16 of the deceleration mechanism does not need to be set at a large value. Thus, a load applied to the last gear 16 of the deceleration mechanism can be reduced. As a result, a progression of gear wear of the pinion gear teeth 41 of the pinion gear 14 and the intermediate gear teeth 42 of the intermediate gear 15, and a progression of gear wear between the intermediate gear teeth 43 of the intermediate gear 15 and the output gear teeth 48 of the last gear 16 can be limited. Moreover, to cope with a valve lock due to foreign substances such as exhaust gas particles attached and deposited on the valve seat surface of the nozzle 5, a reduction ratio of the output shaft 13 of the deceleration mechanism of the electric actuator and the EGR valve 1 fixed to this output shaft 13 can be made large.

In addition, the return mechanism of the electric actuator is configured by adding the spiral spring 8 to the return spring 7. Accordingly, reliability, in returning of the EGR valve 1 from its valve-opening position to fully-closed position can be improved without making larger the spring torque of the return spring 7 than the existing spring 7. As a result, the torque generated by the output shaft 13 of the deceleration mechanism is not reduced. Thus, the gear wear due to a load increase is not caused, and a reduction of efficiency in power transmission between the intermediate gear 15 and the last gear 16 can be limited. Consequently, a high-cost material which is excellent in wear resistance does not need to be used for a material of the last gear 16, to limit the progression of gear wear of the intermediate gear 15 and the last gear 16.

As a result, without increasing the spring torque of the return spring 7 and without using an expensive material which is excellent in wear resistance, torque fluctuation (rotation unevenness and vibration) due to the cogging torque generated in the motor shaft 11 of the DC motor M cannot be transmitted to the output shaft 13 of the deceleration mechanism. Furthermore, a progression of gear wear of the pinion gear teeth 41 of the pinion gear 14 and the intermediate gear teeth 42 of the intermediate gear 15, and a progression of gear wear between the intermediate gear teeth 43 of the intermediate gear 15 and the output gear teeth 48 of the last gear 16 can be limited. Therefore, the EGR control valve having a low cost electric actuator can be manufactured (put into production).

### Second Embodiment

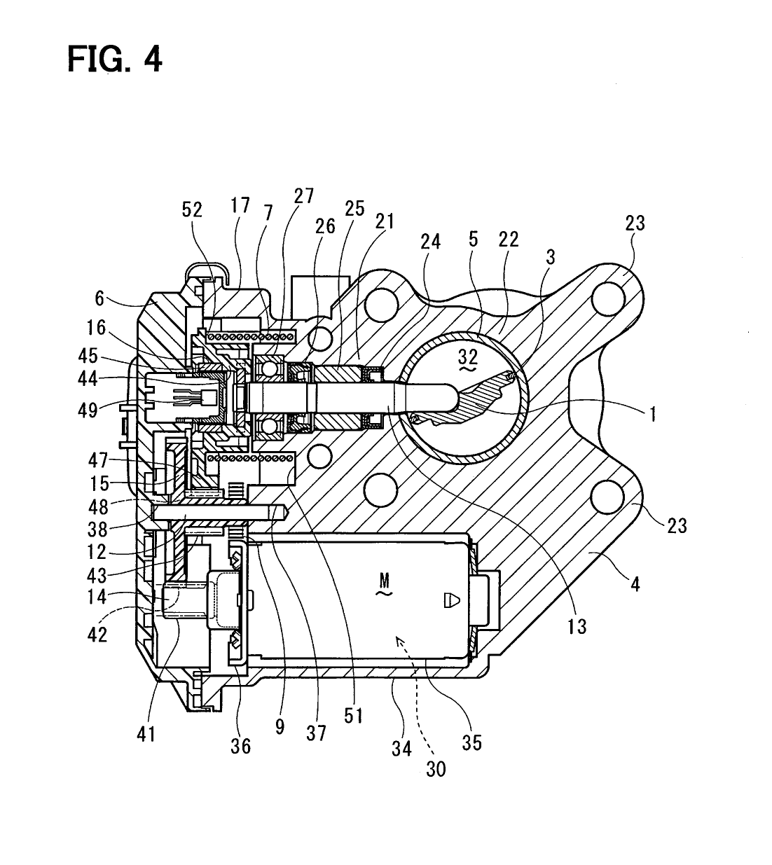

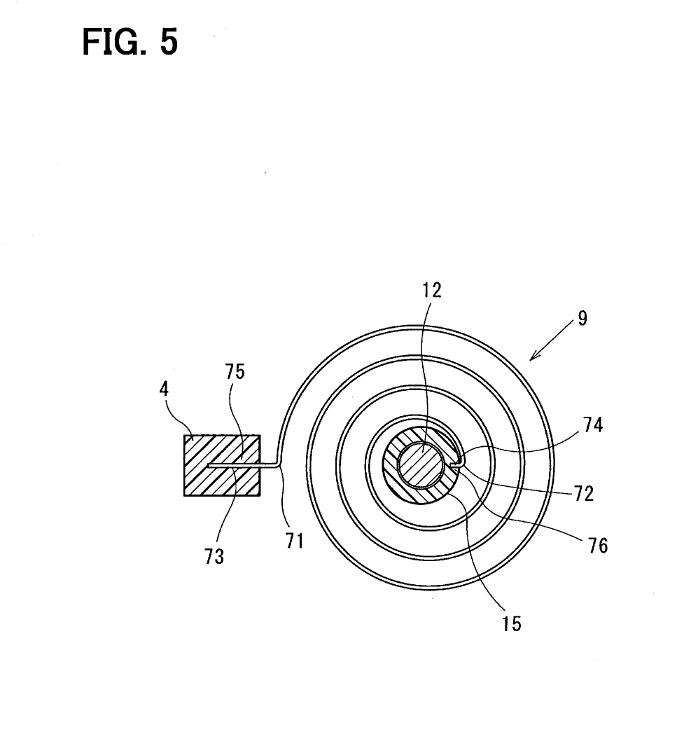

FIGS. 4 and 5 illustrate a second embodiment. FIG. 4 illustrates an EGR control valve, and FIG. 5 illustrates a main part (spiral spring) of a return mechanism of an electric actuator.

The return mechanism of the electric actuator of the present embodiment includes a return spring 7 that is disposed to spirally surround an output shaft 13 of a deceleration mechanism, and a spiral spring 9 that is disposed to vorticosely surround an intermediate gear shaft 12 of the deceleration mechanism. The spiral spring 9 is a spiral spring (second resilient member) which applies urging force (spring load, spring force) that urges the EGR valve 1 in the valve-closing direction, to an intermediate gear 15 of the deceleration mechanism. This spiral spring 9 is a second resilient force applying means (second spring) for applying the resilient force that urges the EGR valve 1 in the direction (valve-closing direction) to return the EGR valve 1 from the valve-opening position to the fully-closed position, to the intermediate gear 15 of the deceleration mechanism.

The spiral spring 9 includes a spiral portion that is wound to vorticosely surround the intermediate gear shaft 12 of the deceleration mechanism and a cylindrical part of the intermediate gear 15. A first end part (maximum outer diameter part) 71 of the spiral portion is provided on one end side (valve body side) of the spiral spring 9 in its spiral direction. A second end part (minimum inner diameter part) 72 of the spiral portion is provided on the other end side (intermediate gear side) of the spiral spring 9 in its spiral direction. The spiral spring 9 includes a first hook portion 73 that projects (extends) outwardly in a radial direction of the spiral portion from a terminal part of the first end part 71 of the spiral portion, and a second hook portion 74 that projects (extends) radially inward from a terminal part of the second end part 72 of the spiral portion.

The first hook portion 73 is embedded and fixed (held or engaged) in a spring holding part 75 that is provided on the gear case 17-side of the valve body 4. The second hook portion 74 is embedded and fixed (held or engaged) in a spring holding part 76 that is provided for the cylindrical part of the intermediate gear 15 of the deceleration mechanism. In addition, the spring holding part 75 may be a block (fixation member fixed to the housing) made of synthetic resin that is press-fitted (fixed) in an outer wall surface of the valve body 4, i.e., a fitting recess provided on a bottom face of the gear case 17. As above, in the EGR control valve of the present embodiment, the return mechanism (spiral spring 9) is configured around the intermediate gear shaft 12 and the intermediate gear 15 of the deceleration mechanism. Accordingly, similar effects to the first embodiment can be produced after the intermediate gear shaft 12.

Modifications to the above embodiments will be described below. In the present embodiments, the nozzle 5 is fitted and held to an inner periphery of the nozzle holder 22 of the valve body 4, and the EGR valve 1 is accommodated in the nozzle 5 such that the valve 1 can open or close in the nozzle 5. Alternatively, the EGR valve 1 may be accommodated directly in a valve accommodating portion of a cylindrical part of the valve body 4 in an openable and closable manner. In this case, the nozzle 5 becomes unnecessary, and the number of components and assembly manhours can thereby be reduced.

The electric actuator of the present embodiments is applied to the electric actuator that drives the movable body (rotatable body) such as the EGR valve 1 which rotates around the output shaft 13 on one side (normal rotation direction, valve-opening direction or valve-closing direction) in its rotation direction. Alternatively, the actuator of the present embodiments may be applied to an electric actuator that drives a movable body that reciprocates in an axial direction on one side in its movement direction. For example, a rotary valve, a butterfly valve, a shutter valve, a ball valve, or a poppet valve may be employed for the movable body. A rotating movable body (rotatable body) such as a compressor, a blower, a pump, a cam, a rotor, or a wheel; or a linearly movable body such as a piston, a rod, or a shaft may be employed for the movable body.

The control valve including the electric actuator of the present embodiments is applied to an EGR control valve. Alternatively, the valve of the present embodiments may be applied to an exhaust gas passage changeover valve that switches between a low-temperature exhaust gas passage that is in communication with an outlet side of an EGR cooler, and a bypass flow passage (high-temperature exhaust gas passage) for EGR gas to bypass the EGR cooler; or an exhaust gas flow rate (pressure) control valve disposed in an exhaust pipe of an engine (turbine housing of a turbocharger). For example, a tumble control valve, a swirl control valve, an intake flow rate control valve, an intake pressure control valve, a passage changeover valve, or an intake throttle valve may be employed for the intake control valve. For example, a wastegate valve, a scroll changeover valve, an exhaust gas flow rate control valve, an exhaust pressure control valve, an exhaust gas changeover valve, or an exhaust throttle valve, may be employed for the exhaust control valve.

In the present embodiments, it is illustrated that when the movable body such as a valve is lifted (or opened) by a predetermined displacement amount, a coil spring and a spiral spring are used for the first and second resilient members that apply resilient force in a direction to return the movable body from the displacement position to the initial position. Alternatively, a torsion bar spring and a flat spring may be used as the first and second resilient members. Moreover, a double coil spring or an irregular pitch coil spring may be employed for the first and second resilient members. In addition, a synthetic rubber, a synthetic resin or a spring member that generates torque which is reactive force to the rotation of the DC motor M of the electric actuator may be employed. A coil spring including a return spring that urges the EGR valve 1 in the valve-closing direction; an overturn spring that urges the EGR valve 1 in the valve-opening direction; and a U-shaped hook portion that is formed by bending a connected portion between the return spring and the overturn spring in an inverted U-shaped manner may be employed for the first resilient member (first spring).

To sum up, the electric actuator and the control valve of the above embodiments can be described as follows.

The electric actuator in the first aspect includes the DC motor M that generates power for driving the movable body 1 in its movement direction, the deceleration mechanism 12 to 16 that decelerates the rotation of the motor shaft 11 of this DC motor M to transmit the rotation to the output shaft 13, and the return mechanism 7, 8, 9 that returns the movable body 1 from the displacement position to the initial position. The deceleration mechanism 12 to 16 of the electric actuator includes the input gear 14 fixed to the motor shaft 11 of the DC motor M, the intermediate gear 15 that rotates in engagement with this input gear 14, the output gear 16 that rotates in engagement with this intermediate gear 15, and the output shaft 13 that is connected to this output gear 16 in an integrally rotatable manner. The return mechanism 7, 8, 9 of the electric actuator includes the first resilient member 7 which applies the resilient force that urges the movable body 1 in a direction to return the movable body 1 from the displacement position to the initial position, to the output shaft 13 or the output gear 16 of the deceleration mechanism 12 to 16; and the second resilient member 8, 9 which applies the resilient force that urges the movable body 1 in a direction to return the movable body 1 from the displacement position to the initial position to the motor shaft 11, the input gear 14, or the intermediate gear 15.

According to the electric actuator in the first aspect, the return mechanism 7, 8, 9 that returns the movable body 1 from the displacement position to the initial position is configured by means of the first resilient member 7 that gives the resilient force to the output shaft 13 or the output gear 16 of the deceleration mechanism 12 to 16; and the second resilient member 8, 9 that gives the resilient force to the motor shaft 11, the input gear 14, or the intermediate gear 15. Accordingly, the cogging torque generated in the motor shaft 11 of the DC motor M can be cancelled out. As above, by providing the second resilient member 8, 9 that gives the resilient force to the motor shaft 11, the input gear 14, or the intermediate gear 15, despite the reduction of efficiency in power transmission of the deceleration mechanism 12 to 16 provided between the motor shaft 11 and the output shaft 13 through the long-term durable use of the electric actuator, the torque fluctuation (rotation unevenness and vibration) due to the cogging torque generated in the motor shaft 11 of the DC motor M is not easily transmitted to the output shaft 13 of the deceleration mechanism 12 to 16.

Accordingly, the torque of the first resilient member 7 that gives the resilient force to the output shaft 13 or the output gear 16 of the deceleration mechanism 12 to 16 does not need to be set at a large value. Thus, the load applied to the output gear 16 of the deceleration mechanism 12-16 can be reduced. As a result, the progression of gear wear of the intermediate gear 15 and the output gear 16 of the deceleration mechanism 12 to 16 can be limited. Consequently, without use of an expensive material which is excellent in wear resistance, the torque fluctuation (rotation unevenness and vibration) due to the cogging torque generated in the motor shaft 11 of the DC motor M cannot be transmitted to the output shaft 13 of the deceleration mechanism 12 to 16. Furthermore, the progression of gear wear of the intermediate gear 15 and the output gear 16 can be limited. Therefore, a low cost electric actuator can be manufactured (put into production).

According to the electric actuator in the second aspect, the return spring 7 that is wound vorticosely or spirally around the output shaft 13 of the deceleration mechanism 12 to 16 is used for the first resilient member 7. According to the electric actuator in the third aspect, the return spring 8 that is wound vorticosely or spirally around the motor shaft 11 is used for the second resilient member 8. The electric actuator in the fourth aspect includes the deceleration mechanism 12 to 16 having the intermediate shaft 12 that is arranged in parallel with the motor shaft 11 and the output shaft 13. According to the electric actuator in the fifth aspect, the return spring 9 that is wound vorticosely or spirally around the intermediate shaft 12 of the deceleration mechanism 12 to 16 is used for the second resilient member 9. In addition, an elastic body such as synthetic rubber or synthetic resin which applies the resilient force that urges the movable body 1 in a direction to return the movable body 1 from the displacement position to the initial position to the motor shaft 11, the input gear 14, or the intermediate gear 15 may be used for the second resilient member 9.

The DC motor M in the sixth aspect includes the rotor 30 which has the commutator fixed to the motor shaft 11, the stator 35, 53, 54 having the cylindrical yoke 35 which surrounds this rotor 30 in its circumferential direction and the permanent magnets 53, 54 fixed on the inner peripheral surface of this yoke 35, and the brushes which are in sliding contact with the commutator. The rotor 30 of the DC motor M in the seventh aspect includes the rotor core fixed to the motor shaft 11, and the rotor coil wound on this rotor core. In addition, the commutator is electrically connected to the rotor coil. For example, the direct current (DC) motor with a brush, where the stator in which the permanent magnets 53, 54 are fixed on the inner peripheral surface of the yoke 35 having a cylindrical shape with a bottom; a rotor (armature) 30 that is rotatably disposed radially inward of this stator with a predetermined gap therebetween; and the brushes that feed power to this rotor 30 are provided, is employed for the DC motor M. In the DC motor M, upon supply of the direct current to the armature coil, a magnetic field is formed, and the rotor 30 rotates due to the magnetic attraction and repulsion produced between this magnetic field and the permanent magnets 53, 54. A change of magnetic flux becomes large on both ends of the permanent magnets 53, 54 in their circumferential direction. Accordingly, when the teeth pass through both the ends of the permanent magnets 53, 54 in their circumferential direction, the magnetic attraction and repulsion of the teeth are greatly changed. As a result, the cogging torque becomes large, and the vibration of the DC motor M thereby becomes large.

The control valve including the electric actuator in the eighth aspect includes the housing 4, 5 that defines the passage 31 to 33 through which fluid flows, the valve 1 which opens and closes the passage 31 to 33, and the electric actuator that drives this valve 1 for example, in the valve-opening direction or valve-closing direction. The electric actuator includes the DC motor M that generates the power which drives the valve 1 in its valve-opening direction; the deceleration mechanism 12 to 16 that decelerates the rotation of the motor shaft 11 of this DC motor M to transmit the rotation to the output shaft 13; and the return mechanism 7, 8, 9 that returns the valve 1 from the displacement position (valve-opening position or fully-closed position) to the initial position (fully-closed position or fully-open position).

The deceleration mechanism 12 to 16 of the electric actuator includes the input gear 14 fixed to the motor shaft 11 of the DC motor M, the intermediate gear 15 that rotates in engagement with this input gear 14, the output gear 16 that rotates in engagement with this intermediate gear 15, and the output shaft 13 that is connected to this output gear 16 in an integrally rotatable manner. The return mechanism 7, 8, 9 of the electric actuator includes the first resilient member 7 which applies the resilient force that urges the valve 1 in a direction to return the valve 1 from the displacement position (valve-opening position or fully-closed position) to the initial position (fully-closed position or fully-open position), to the output shaft 13 or the output gear 16 of the deceleration mechanism 12 to 16; and the second resilient member 8, 9 which applies the resilient force that urges the valve 1 in a direction to return the valve 1 from the displacement position (valve-opening position or fully-closed position) to the initial position (fully-closed position or fully-open position), to the motor shaft 11, the input gear 14, or the intermediate gear 15.

According to the control valve in the eighth aspect, the return mechanism 7, 8, 9 is constituted of the first resilient member 7 which applies the resilient force that urges the valve 1 in a direction to return the valve 1 from the displacement position to the initial position, to the output shaft 13 or the output gear 16 of the deceleration mechanism 12 to 16; and the second resilient member 8, 9 which applies the resilient force that urges the valve 1 in a direction to return the valve 1 from the displacement position to the initial position to the motor shaft 11, the input gear 14, or the intermediate gear 15. Accordingly, the cogging torque generated in the motor shaft 11 of the DC motor M can be cancelled out. As described above, by providing the second resilient member 8, 9 that gives the resilient force to the motor shaft 11, the input gear 14, or the intermediate gear 15, despite the reduction of efficiency in power transmission of the deceleration mechanism 12 to 16 provided between the motor shaft 11 and the output shaft 13 through the long-term durable use of the electric actuator, the torque fluctuation (rotation unevenness and vibration) due to the cogging torque generated in the motor shaft 11 of the DC motor M is not easily transmitted to the output shaft 13 of the deceleration mechanism 12 to 16.

Accordingly, the torque of the first resilient member 7 that gives the resilient force to the output shaft 13 or the output gear 16 of the deceleration mechanism 12 to 16 does not need to be set at a large value. Thus, the load applied to the output gear 16 of the deceleration mechanism 12-16 can be reduced. As a result, the progression of gear wear of the intermediate gear 15 and the output gear 16 of the deceleration mechanism 12 to 16 can be limited. Thus, without use of an expensive material which is excellent in wear resistance, the torque fluctuation (rotation unevenness and vibration) due to the cogging torque generated in the motor shaft 11 of the DC motor M cannot be transmitted to the output shaft 13 of the deceleration mechanism 12 to 16. Furthermore, the progression of gear wear of the intermediate gear 15 and the output gear 16 can be limited. Therefore, the control valve including a low cost electric actuator can be manufactured (put into production).

According to the control valve in the ninth aspect, the first spring 7 which gives the resilient force that urges the valve 1 in a direction to return the valve 1 from the valve-opening position corresponding to the displacement position to the fully-closed position corresponding to the initial position, to the output shaft 13 or the output gear 16 of the deceleration mechanism 12 to 16, is used for the first resilient member 7. According to the control valve in the tenth aspect, one end of the first spring 7 is engaged with the output gear 16 of the deceleration mechanism 12 to 16, and the other end of the first spring 7 is engaged with the housing 4, 5 or an attachment member fixed to this housing 4, 5.

According to the control valve in the eleventh aspect, the second spring 8, 9 that gives the resilient force that urges the valve 1 in a direction to return the valve 1 from the valve-opening position corresponding to the displacement position to the fully-closed position corresponding to the initial position to the motor shaft 11, the input gear 14, or the intermediate gear 15, is used for the second resilient member 8, 9. According to the control valve in the twelfth aspect, one end of the second spring 8, 9 is engaged with the input gear 14 or the intermediate gear 15 of the deceleration mechanism 12 to 16; and the other end of the second spring 8, 9 is engaged with the housing 4, 5 or an attachment member 65, 75 fixed to this housing 4, 5.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An electric actuator for driving a movable body, the electric actuator comprising:
a direct current (DC) motor that is configured to generate power which drives the movable body in its movement direction;
a deceleration mechanism that includes:
an input gear fixed to a motor shaft of the DC motor;
an intermediate gear rotated in engagement with the input gear;
an output gear rotated in engagement with the intermediate gear; and
an output shaft coupled with the output gear to be rotatable integrally with the output gear, wherein the deceleration mechanism is configured to decelerate rotation of the motor shaft and to transmit the decelerated rotation to the output shaft; and
a return mechanism that includes:
a first resilient member configured to apply resilient force, which urges the movable body in a direction to return the movable body from its displacement position to initial position, to the output shaft or the output gear; and
a second resilient member configured to apply resilient force, which urges the movable body in the direction to return the movable body from its displacement position to initial position, to the motor shaft, the input gear, or the intermediate gear.

2. The electric actuator according to claim 1, wherein the first resilient member is a return spring that is wound vorticosely or spirally around the output shaft.

3. The electric actuator according to claim 1, wherein the second resilient member is a return spring that is wound vorticosely or spirally around the motor shaft.

4. The electric actuator according to claim 1, wherein the deceleration mechanism further includes an intermediate shaft that is arranged in parallel with the motor shaft and the output shaft.

5. The electric actuator according to claim 4, wherein the second resilient member is a return spring that is wound vorticosely or spirally around the intermediate shaft.

6. The electric actuator according to claim 1, wherein the DC motor includes:
a rotor having a commutator which is fixed to the motor shaft;
a stator having:
a cylindrical yoke which surrounds the rotor in its circumferential direction; and
a plurality of permanent magnets which are fixed on an inner peripheral surface of the yoke; and
a plurality of brushes which are in sliding contact with the commutator.

7. The electric actuator according to claim 6, wherein:
the rotor further includes a rotor core fixed to the motor shaft, and a rotor coil wound on the rotor core; and
the commutator is electrically connected to the rotor coil.

8. A control valve comprising:
the electric actuator recited in claim 1;
a housing that defines a flow passage through which fluid flows; and
the movable body that is a valve configured to open or close the flow passage, wherein the DC motor is configured to generate power which drives the valve in its opening direction.

9. The control valve according to claim 8, wherein the first resilient member is a first spring configured to apply resilient force, which urges the valve in a direction to return the valve from a valve-opening position corresponding to the displacement position to a fully-closed position corresponding to the initial position, to the output shaft or the output gear.

10. The control valve according to claim 9, wherein:
one end of the first spring is engaged with the output gear; and
the other end of the first spring is engaged with the housing or an attachment member which is fixed to the housing.

11. The control valve according to claim 8, wherein the second resilient member is a second spring configured to apply resilient force, which urges the valve in a direction to return the valve from a valve-opening position corresponding to the displacement position to a fully-closed position corresponding to the initial position, to the motor shaft, the input gear, or the intermediate gear.

12. The control valve according to claim 11, wherein:
one end of the second spring is engaged with the input gear or the intermediate gear; and
the other end of the second spring is engaged with the housing or an attachment member which is fixed to the housing.
